(19) United States
(12) Patent Application Publication
(10) Pub. No.: US 2025/0355488 A1
(43) Pub. Date: Nov. 20, 2025

(54) SENSOR-TRIGGERED DISPLAY PANEL SYSTEM FOR SERVER INFORMATION RETRIEVAL

(71) Applicant: Aivres Systems Inc., San Jose, CA (US)

(72) Inventor: Shi-Wei WANG, Taipei (TW)

(21) Appl. No.: 19/289,094

(22) Filed: Aug. 3, 2025

(51) Int. Cl. G06F 3/01; G06F 1/16; G06F 1/3231

(52) U.S. Cl. CPC G06F 3/011; G06F 1/1607; G06F 1/3231

(57) ABSTRACT

A device for displaying system information of a server includes a display assembly movably mounted to the chassis of the server, a sensor for detecting user interaction with the display assembly, and a control circuit. When the display assembly is pulled out, the sensor generates a trigger signal, prompting the control circuit to retrieve system information from a system management controller, such as a baseboard management controller (BMC). The system information may include a subset of data retrievable when the server is powered off or in standby, such as manufacturing details, FRU data, or sensor readings. The retrieved information is presented on the display panel. The control circuit is programmable to configure which types of system information to retrieve. The system operates without requiring full system boot-up, enabling quick and efficient access to server status and configuration data via an integrated, retractable user interface.

### TECHNICAL FIELD

This invention relates generally to server hardware management systems, and more particularly to an integrated display panel and programmable control system for presenting server-specific information such as configuration, firmware versions, and operational parameters, in response to physical user interaction.

### BACKGROUND

In current server manufacturing and deployment processes, system identification and configuration information is typically provided by affixing a printed label—commonly referred to as a service tag—to the server chassis. These labels often include a QR code that allows users to scan and retrieve basic factory information such as the server model, serial number, and shipment date. This solution has been widely adopted as a convenient way to convey static product data.

However, this conventional approach suffers from multiple operational drawbacks. First, the application of service tag stickers is a manual process performed prior to shipment. This introduces significant room for human error: labels may be forgotten, incorrectly applied, or rendered invalid if the server configuration changes after the sticker is printed. Such mistakes often result in rework, shipping delays, and increased manufacturing costs. Additionally, service tag stickers must be produced in large quantities and customized for each product variation, further adding to production complexity.

Second, the static nature of these labels limits their usefulness in the field. They only contain fixed factory data and cannot provide real-time information about the system's firmware, software, configuration, or operational state. Maintenance personnel must often resort to external tools—such as laptops, keyboards, barcode scanners, or network interfaces—to retrieve updated server data, increasing both labor and service time.

Some systems attempt to improve usability by embedding a retractable tray or panel with a QR-code sticker affixed to it, allowing users to scan the server information more easily. While this offers some ergonomic advantages, it does not address the core issues: the information remains static, error-prone, and disconnected from the server's runtime state.

Accordingly, there is a clear need for a more reliable and cost-effective solution that reduces human error during production, enables dynamic system information access, and simplifies maintenance.

### SUMMARY

A system comprising one or more computers may be configured to perform specific operations or actions by virtue of having software, firmware, hardware, or a combination thereof installed on the system, which, in operation, causes the system to perform the actions. One or more computer programs may be configured to perform particular operations or actions by virtue of including instructions that, when executed by a data processing apparatus, cause the apparatus to perform the actions.

In one general aspect, a device may include a display assembly movably mounted to a chassis of a server. The display assembly may include a display panel and a sensor configured to detect user interaction with the display assembly and to generate a trigger signal in response to the user interaction.

The device may also include a control circuit disposed within the chassis, electrically coupled to the display assembly and to a system management controller of the server. The control circuit may be configured to automatically retrieve system information from the system management controller in response to the trigger signal via a communication interface. The system information may include at least a set of information retrievable when the server is in a powered-off or standby state. The control circuit may further be configured to provide the retrieved system information to the display panel for presentation. In some embodiments, the control circuit is programmable to configure the system information to be retrieved. Other embodiments of this aspect include corresponding computer systems, apparatus, and computer programs recorded on one or more computer storage devices, each configured to perform the actions of the methods.

Implementations may include one or more of the following features. In some embodiments, the user interaction may include pulling out the display assembly from the chassis while the display assembly remains mechanically coupled to the chassis and electrically coupled to the control circuit, such that pulling out the display assembly automatically triggers retrieval of the system information through the system management controller of the server. In some embodiments, the sensor includes a light sensor configured to detect light exposure when the display assembly is pulled out from the chassis.

The control circuit may include a programmable logic device implemented using a field-programmable gate array (FPGA), a complex programmable logic device (CPLD), or a microcontroller unit (MCU). The system management controller may include a baseboard management controller (BMC). The communication interface between the control circuit and the system management controller may include an inter-integrated circuit (I2C) bus or a serial general-purpose input/output (SGPIO) interface.

The display panel may be operatively coupled to the control circuit via a flexible flat cable (FFC) disposed within the chassis. In some embodiments, the display panel is configured to present one or more of the following: a model identifier, a manufacturing date, a firmware version, a software version, a hardware configuration, or a temperature reading associated with the server. The set of information retrieved when the server is in the powered-off or standby state may include a model identifier, a manufacturing location, a manufacturing date, a serial number, field replaceable unit (FRU) data, or system voltage or temperature sensor data.

In some cases, the control circuit is further configured to automatically retrieve, in response to the trigger signal, at least one of a model identifier, manufacturing date, firmware version, software version, or field replaceable unit (FRU) data stored in non-volatile memory accessible by the system management controller during the powered-off or standby state of the server. The control circuit may also be configured to write one or more values to one or more registers associated with the control circuit, where the values indicate one or more types of system information to be retrieved from the system management controller.

The display assembly may be retractable and mounted to a side or bottom portion of the chassis. In some implementations, the display panel is configured to render content using a graphical user interface (GUI).

Implementations of the described techniques may include hardware, a method or process, or a computer-readable medium storing instructions executable to cause one or more processors to perform the described operations.

In one general aspect, a method may include detecting user interaction with a display assembly movably mounted to a chassis of the server, where the user interaction may include pulling out the display assembly from the chassis while the display assembly remains mechanically coupled to the chassis. The method may further include generating a trigger signal in response to the detected user interaction.

The method may also include retrieving, by a control circuit electrically coupled to a system management controller of the server, system information from the system management controller in response to the trigger signal. The system information may include a first set of information retrievable when the server is in a powered-off or standby state. The method may additionally include providing the retrieved system information to a display panel of the display assembly for display. The control circuit may be programmable to configure the system information to be retrieved. Other embodiments of this aspect include corresponding computer systems, apparatus, and computer programs recorded on one or more computer storage devices, each configured to perform the actions of the methods.

Implementations may include one or more of the following features. The method may include writing one or more values to one or more registers associated with the control circuit, the values indicating one or more types of system information to be retrieved from the system management controller. The retrieving operation may include communicating with the system management controller via an I²C bus or SGPIO interface. In some embodiments, retrieving the system information from the system management controller may include automatically retrieving, in response to the trigger signal, at least one of a model identifier, manufacturing date, firmware version, software version, or FRU data stored in non-volatile memory that is accessible by the system management controller during the powered-off or standby state of the server.

The control circuit may include a programmable logic device implemented using an FPGA, CPLD, or MCU. Providing the retrieved system information to the display panel may include transmitting the system information through a flexible flat cable (FFC). Retrieving system information from the system management controller may include automatically retrieving the first set of information that is retrievable when the server is in the powered-off or standby state, reading one or more registers associated with the control circuit to determine a second set of system information to be retrieved from the system management controller when the server is in a power-on state, and automatically retrieving the second set of system information.

Implementations of the described techniques may include hardware, a method or process, or a computer-readable medium.

### BRIEF DESCRIPTION OF THE DRAWINGS

FIG. 1 is a diagram illustrating an example of an existing server system configuration, including a service tag compartment at a designated chassis location.

FIG. 2 is a block diagram of an example sensor-equipped system information display assembly, in accordance with some embodiment.

FIG. 3 illustrates an example control circuit architecture implemented on a printed circuit board (PCB), in accordance with some embodiments.

FIG. 4 illustrates an architecture for hybrid retrieval and display of system information, in accordance with some embodiments.

FIG. 5 illustrates an example graphical user interface (GUI) rendered on a display panel of a display assembly, in accordance with some embodiments.

FIG. 6 is a flowchart of an example process 600, in accordance with some embodiments

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

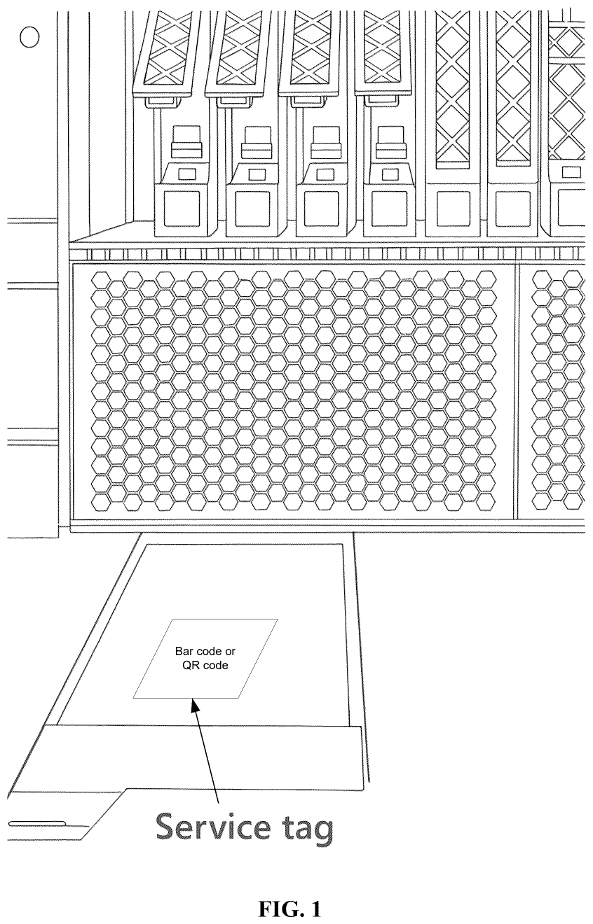

FIG. 1 is a diagram illustrating an example of an existing server system configuration, including a service tag compartment at a designated chassis location. As shown, the chassis includes a plurality of modular component bays configured to receive server components (e.g., hot-swappable devices, such as hard drives or solid-state storage units), as well as a vented region to support system airflow. Disposed near the lower portion of the chassis front panel is a pull-out service tag tray, which, in current server configurations, includes a static identification label such as a barcode or QR code printed on a surface of the tray.

In existing systems, the service tag is pre-associated with limited system-related information, such as a serial number, product model, or service code. In field operations, a technician or data center operator needs to manually pull out the service tag tray, use a separate mobile scanning device (e.g., a smartphone or tablet), and then connect to a network or backend database to retrieve further information associated with the scanned code-such as warranty status, deployment records, or system configuration data.

This process, while adequate in small-scale deployments, introduces several challenges in modern, large-scale, or high-density data center environments. For example, technicians may inadvertently scan the wrong unit, misrecord retrieved data, or struggle to obtain live configuration status due to network latency or authentication issues. Additionally, such workflows rely on the availability of external devices and backend services, which may hinder efficiency during time-sensitive maintenance windows or in environments with constrained network access.

To address these limitations, the present disclosure introduces a sensor-equipped system information display assembly that may be mounted in place of the conventional service tag tray. Unlike static physical labels, the described system includes a user-triggered display capable of retrieving and presenting relevant system information directly at the point of access, such as part numbers, firmware versions, temperature readings, or asset metadata. The improved assembly maintains compatibility with existing server front-panel architecture while enabling hybrid retrieval and display of system information, eliminating the need for manual scanning, reducing operational errors, and improving visibility and responsiveness in increasingly complex server environments.

In the context of the present disclosure, the term “hybrid retrieval and display of system information” refers to a system in which both pre-fetched (static system information) and real-time system information (dynamic system information) can be presented on a local display panel that is physically integrated with the server chassis.

For example, the static system information may refer to data that is pre-fetched or pre-retrieved from non-volatile memory and stored locally within the display control circuit. This static information may include, for example, the server's model identifier, serial number, manufacturing date and location, field-replaceable unit (FRU) part numbers, and other immutable or infrequently updated metadata. Such data can be retrieved from a baseboard management controller (BMC) or similar system management controller even when the server is in a powered-off or standby state, and stored in a cache or register set associated with the display controller.

The dynamic system information, by contrast, refers to system state or configuration data that is retrieved on demand, in real-time, based on user-defined selections or operational triggers. For instance, an operator may configure the control circuit to additionally fetch live temperature readings, firmware versions, fan speeds, power status, or other health monitoring metrics that are available when the server is in an operational (powered-on) state. These parameters may be selected via preconfigured registers in the control circuit and retrieved upon detecting user interaction, such as pulling out the display assembly.

By combining static and dynamic data presentation, the disclosed system allows the operator to obtain a comprehensive real-time overview of the server's identity and status without requiring external devices, network access, or backend systems.

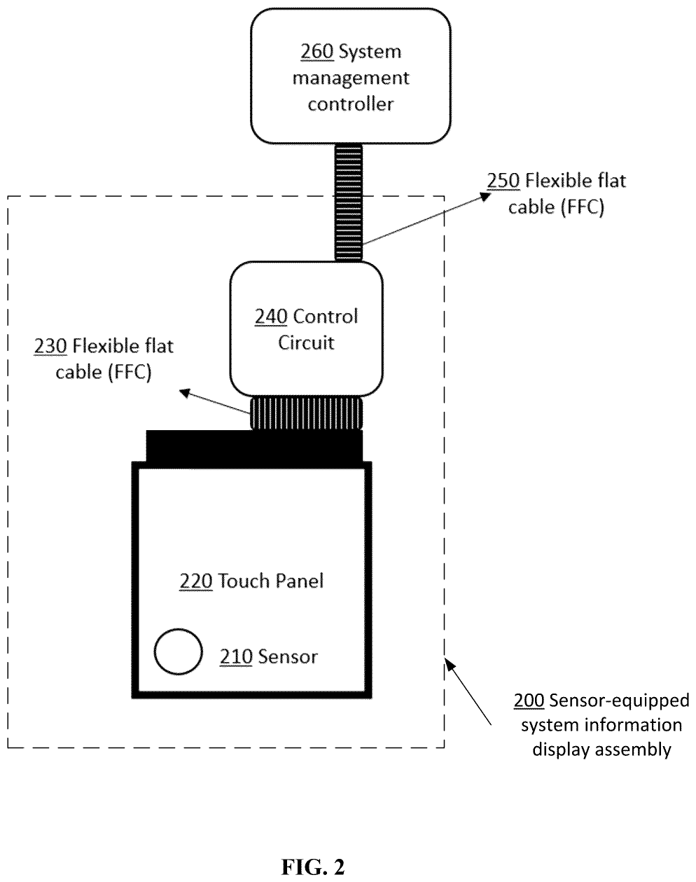

FIG. 2 illustrates a block diagram of a sensor-equipped display assembly 200 for displaying system information (also referred to as a display assembly), in accordance with some embodiments. In this example illustration, the sensor-equipped display assembly 200 includes a control circuit 240, a display assembly having a display panel 220 (e.g., a touch screen panel) and at least one sensor 210, and two sets of flexible flat cables (FFC). A first FFC (230) connects the control circuit 240 to the display panel 220 and sensor 210. A second FFC (250) connects the control circuit 240 to a system management controller 260 of a server.

In an embodiment, the sensor 210 may be a light sensor, infrared sensor, or other suitable proximity or motion sensor that detects user interaction with the display assembly 200. In one implementation, the user interaction may include physically pulling out or sliding out the display assembly 200 from the server chassis. Upon such action, the sensor 210 generates a trigger signal and transmits it through the first FFC 230 to the control circuit 240. For example, the sensor 210 may be a light sensor positioned on the inner edge of the display assembly such that the sensor 210 is shielded from ambient light when the display panel 220 is in a stowed position. When a user pulls out the display assembly from the chassis, the sensor 210 is exposed to ambient light, resulting in a change in light intensity that is detected by the sensor 210. This change triggers the sensor 210 to generate the signal indicating user interaction.

In an embodiment, the control circuit 240 may include a programmable logic device such as a field-programmable gate array (FPGA), a complex programmable logic device (CPLD), or a microcontroller unit (MCU). The control circuit 240 is programmed and configured to selectively retrieve different types of system information based on a set of programmable parameters. In one example, the control circuit 240 includes a set of registers, each corresponding to a different type of system information that may be queried from the system management controller 260. These registers may be predefined by the system (e.g., factory defaults) or customized by a user (e.g., through the display panel 220 or through a software configuration interface during system deployment or provisioning).

Each register may store a flag or value indicating whether a particular type of information—such as model identifier, firmware version, FRU data, system voltage, or temperature—is to be retrieved. When the control circuit 240 receives the trigger signal from the user interaction, the control circuit 240 reads these registers and, based on the active flags, sends corresponding requests to the system management controller 260 to retrieve the selected system data.

In one implementation, the retrieved data may be stored in a separate set of registers or memory buffers within the control circuit 240, distinct from the configuration registers. These storage registers serve as temporary holding space for the retrieved data, which is then passed to the display panel 220 via the FFC 230 for presentation to the user. This separation allows the control circuit 240 to preserve user preferences across sessions while keeping real-time display data isolated and updatable.

In another implementation, the customization may be implemented using a lookup table stored in non-volatile memory (e.g., EEPROM or flash) coupled to the control circuit 240. The table maps user-selectable profile IDs to sets of system info parameters. For example, a technician might select a “Field Service Mode” that instructs the control circuit 240 to retrieve hardware diagnostics and temperature history, whereas a “Logistics Mode” might only show serial numbers, manufacturing date, and firmware version. When a particular profile is activated—e.g., via a DIP switch or GUI input on the display panel 220—the control circuit 240 loads the corresponding retrieval instructions from the lookup table and performs the fetch accordingly.

In some embodiments, the system management controller 260 may be implemented using a baseboard management controller (BMC) or another suitable embedded system management device known in server technology. The BMC may include non-volatile storage and other components capable of storing both static (pre-fetched) and dynamic (real-time retrieved) system information. Examples of static information include a server serial number, manufacturing date and location, model identifier, and field-replaceable unit (FRU) data. Examples of dynamic information include temperature readings, fan speeds, firmware versions, software versions, and various runtime diagnostics.

The communication between the control circuit 240 and the system management controller 260 may utilize embedded communication protocols such as an inter-integrated circuit (I2C) bus or serial general-purpose input/output (SGPIO) interfaces. Upon retrieving the configured system information, the control circuit 240 subsequently transmits the information to the display panel 220 through the first FFC 230. The FFC 230 and 250 offer several practical benefits in this design that reuses the limited space associated with the existing pull-out service tag tray. The FFC 230 and 250 are thin, flat, and bendable, which makes them suitable for routing within the limited internal space of a server chassis. Additionally, the FFC 230 and 250 support horizontal insertion and low-profile connections, enabling clean mechanical integration between components such as the retractable display assembly and the control circuit. Furthermore, the FFC 230 and 250 enhance the mechanical flexibility needed for the display assembly (including the display panel 220) that moves or slides during user interaction.

In some embodiments, the display panel 220 may include an integrated capacitive or resistive touchscreen to enable user interaction, such as navigating through displayed information or selecting different categories of data to view. The display panel 220 serves both display and customization purposes (e.g., as an input device using a touch screen). In addition to presenting system information, the display panel 220 may provide a user interface that allows the user to customize which system information is to be retrieved and displayed. Such customization may be achieved through interactive selection options presented on the display, and the selected preferences are then stored in corresponding registers of the control circuit 240. In this way, the customization is preserved for future interactions, allowing the system to automatically retrieve and display the user-specified information when triggered again.

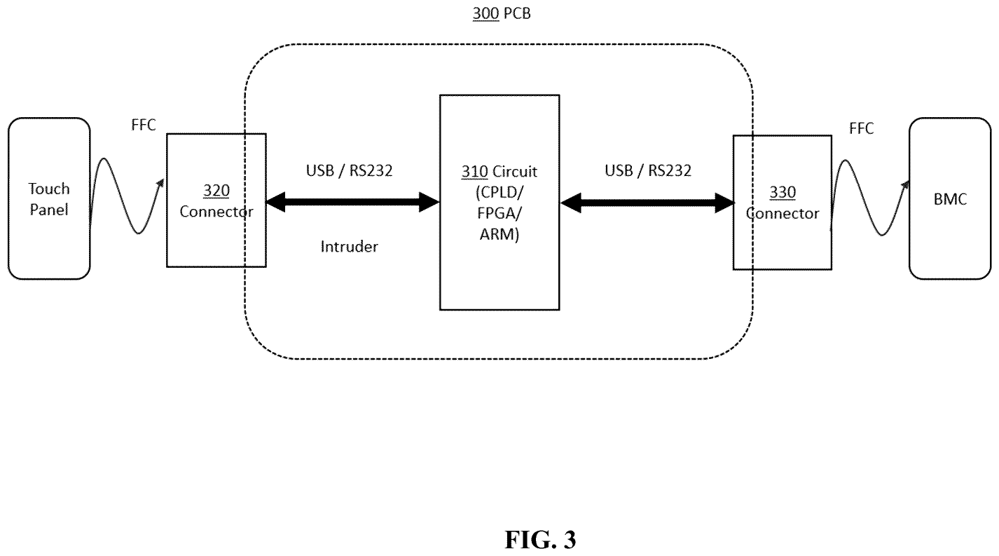

FIG. 3 illustrates an example control circuit architecture implemented on a printed circuit board (PCB) 300, in accordance with some embodiments. In operation, when a user physically interacts with the display assembly-such as by pulling the touch panel outward from the server chassis-a sensor (e.g., a light sensor) detects this motion and generates a trigger signal. This user interaction automatically initiates the retrieval of system information from the baseboard management controller (BMC) for presentation on the touch panel. The triggering user action is labeled as “Intruder” in FIG. 3, indicating the event that activates the information retrieval sequence managed by the control circuit.

In the embodiment illustrated in FIG. 3, the control circuit 310 may be implemented using any of a complex programmable logic device (CPLD), a field-programmable gate array (FPGA), or an ARM-based microcontroller, each representing a programmable hardware platform suitable for managing the retrieval and presentation of system information. In various embodiments, a CPLD may be selected for its deterministic control logic and fast startup characteristics; an FPGA may be employed for its capacity to perform parallel processing and fine-grained configurability; or an ARM-based microcontroller may be used to execute firmware-based control operations in a resource-efficient manner.

As shown in FIG. 3, the PCB 300 may further include two connectors—320 and 330—that are electrically connected to the control circuit 310, and interface with the touch panel and the baseboard management controller (BMC), respectively. In one example, the connections between the control circuit 310 and the connectors may utilize USB or RS-232 serial interfaces. RS-232 refers to a communication standard, which provides simple and robust point-to-point signaling and is compatible with a broad range of embedded system architectures.

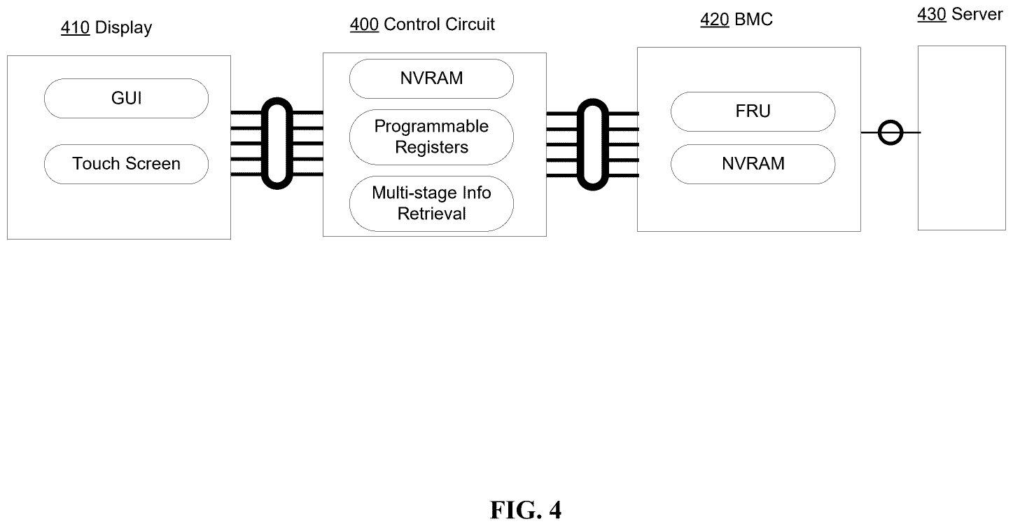

FIG. 4 illustrates an architecture for hybrid retrieval and display of system information, in accordance with some embodiments. The illustrated system includes a display assembly 410, a programmable control circuit (e.g., control circuit 400), a system management controller (e.g., BMC 420), and a server 430. A person skilled in the art would appreciate that the system management controller may be part of the server 430 or electrically coupled to the server 430. These components cooperate to retrieve and display both static and dynamic system information based on user interaction.

As shown, the system includes the display assembly 410, control circuit 400, BMC 420, and the server 430. The components are interconnected via internal cabling, such as flexible flat cables (FFCs), which in some embodiments are used to enable reliable, low-profile routing in the limited space of a server chassis. The bendable form factor of FFCs facilitates horizontal plug-in configurations and reduces mechanical strain in dynamic or retractable modules.

In some embodiments, the display assembly 410 includes a touchscreen capable of serving both as an output interface for visualizing data and as a user input interface. The touchscreen may incorporate a graphical user interface (GUI) that allows an operator to navigate through displayed content and perform configuration tasks directly. For example, the GUI may allow the user to select specific categories of system information to be retrieved or to define preferences for automatic retrieval behavior. In some embodiments, such user configuration is preserved for subsequent uses by storing the associated data in programmable registers within the control circuit 400.

For example, user customization may be preserved in programmable registers implemented using non-volatile memory technologies-such as EEPROM-backed storage or battery-backed SRAM-so that the configuration persists even after power cycles. When the user selects or deselects particular system information (e.g., firmware version, temperature readings, FRU data) through the GUI on the display assembly 410, the control circuit 400 updates specific register values (e.g., flags, index codes, or bitmaps) accordingly. These register values are later read whenever the system retrieves data, such as in response to a sensor-detected trigger (e.g., pulling out the display assembly), ensuring consistent and user-defined behavior.

In some embodiments, one or more of the registers may indicate a type of system information to be retrieved and displayed when the server is in a power-off or standby state. These registers may map to predefined categories of system data-such as static identification information (e.g., model ID, serial number) and diagnostics data (e.g., previously recorded temperature values). In one embodiment, the control circuit 400 performs a staged retrieval process by first checking its register configuration, then initiating communication with the BMC 420. If the server 430 is in a powered-off or standby state, only a subset of non-volatile information (e.g., stored in BMC FRU memory or NVRAM) is accessible. This subset may be retrieved immediately and displayed via the GUI on the display assembly 410 upon being pulled out. In other embodiments, additional data may be designated for dynamic retrieval upon detecting a power-on state of the server 430. Because the register configuration persists in non-volatile storage, the behavior of the display assembly remains consistent across reboots and power transitions.

In some embodiments, the control circuit 400 is implemented as a complex programmable logic device (CPLD), a field-programmable gate array (FPGA), or an ARM-based microcontroller. The control circuit 400 may include programmable registers, a non-volatile memory region for persistent configuration and caching, and a multi-stage data retrieval logic. These internal components work together to execute customized retrieval flows, manage information caching, and update the display assembly 410 based on stored preferences and real-time system states.

The control circuit 400 may interface with the BMC 420 to obtain system-related data via a communication protocol, such as I2C or SGPIO. The BMC 420, in turn, accesses internal storage (e.g., FRU and NVRAM) that houses critical system metadata, including model identifiers, serial numbers, firmware versions, temperature readings, and manufacturing information.

In some embodiments, the system is configured to automatically present pre-fetched and live-fetched system information on the display panel in response to a user interaction with the display assembly, wherein the presentation is performed based on data retrieved through a local communication interface between the control circuit and the system management controller, and without requiring a scanning device or network-based retrieval mechanism. The pre-fetched data, referred to herein as static information, may have been retrieved and stored during a previous session, or may be directly accessible from the BMC 420 during standby or power-off states. The inclusion of static data ensures that the enhanced display solution offers at least the same baseline functionality as traditional service tags, while also improving accessibility.

In addition to static data, the architecture further supports dynamic, real-time retrieval of system information once the server 430 is in a powered-on state. For instance, after the initial presentation of pre-fetched data, the control circuit 400 may query the BMC 420 for live telemetry or updated configuration records. These include, but are not limited to, current voltage levels, zone-specific temperatures, firmware updates, or newly recorded FRU entries. The real-time retrieval process may be governed by the same programmable registers that control static data retrieval, enabling the system to flexibly adapt its behavior based on user-defined monitoring and management preferences.

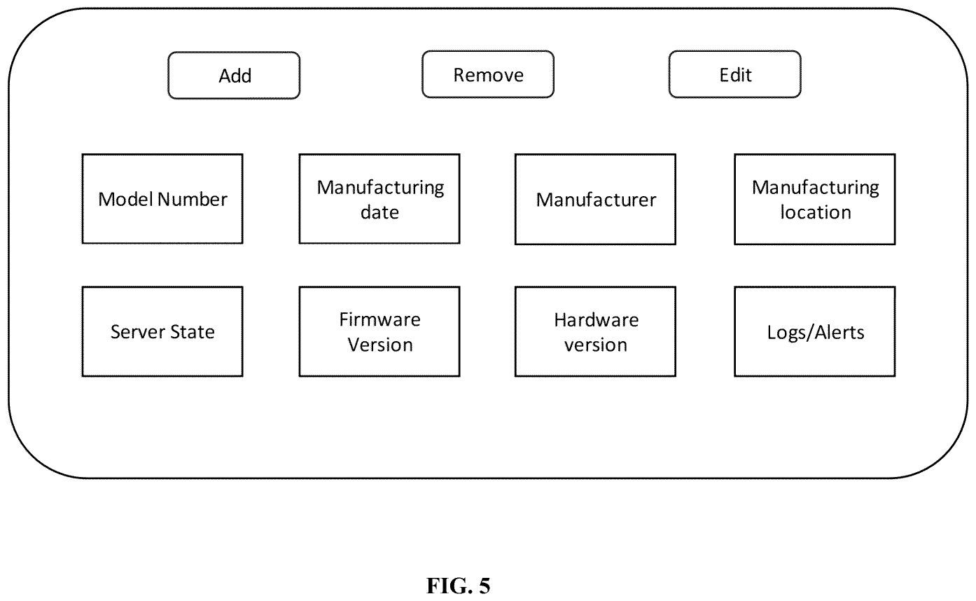

FIG. 5 illustrates an example graphical user interface (GUI) rendered on a display panel of a display assembly, in accordance with some embodiments. The GUI may be generated by the control circuit based on system information retrieved from a system management controller (e.g., a BMC), and presented in response to a user interaction, such as pulling out the display assembly from the server chassis.

As shown, the GUI includes a collection of system information fields displayed in an organized layout. These fields may include, but are not limited to model number, manufacturing date, manufacturer, manufacturing location, server state, firmware version, hardware version, and logs or alerts. In some embodiments, these information items may correspond to values retrieved from non-volatile storage (e.g., FRU or BMC NVRAM), while in other embodiments, certain fields may be populated via real-time queries to the BMC when the server is in a powered-on state. This display allows operators to quickly verify key device identifiers, firmware baselines, and operational logs, without relying on external diagnostic tools or network connectivity.

In some embodiments, the user selections and preferences made through these GUI controls are stored locally in programmable registers of the control circuit. This ensures that the configuration persists across power cycles and is automatically reapplied during future retrieval operations.

In some embodiments, the GUI includes one or more interactive elements configured to enable user customization of the displayed content. As illustrated, the GUI provides buttons labeled “Add,” “Remove,” and “Edit,” which allow the user to modify the set of system information items shown on the display. The “Add” button may be used to include new types of data in the display (e.g., temperature sensor readings or asset tag). The “Remove” button allows the user to deselect and hide information fields that are not of interest. The “Edit” button may enable users to rearrange the order of the items, rename labels for better readability, or modify threshold settings for alerts.

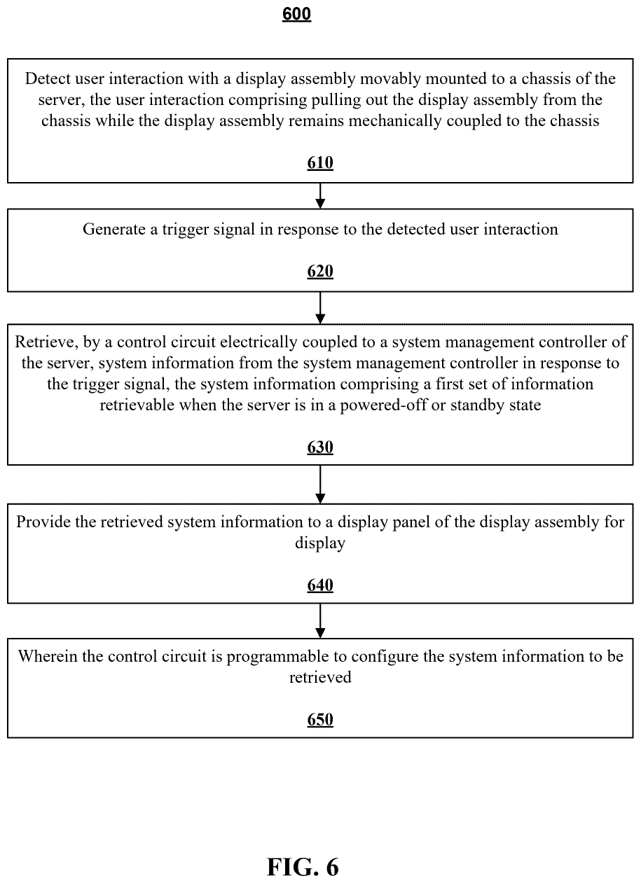

FIG. 6 is a flowchart of an example process 600, in accordance with some embodiments. In some embodiments, one or more process blocks of FIG. 6 may be performed by a device, the device including a control circuit and a display assembly.

As shown in FIG. 6, process 600 may include detecting user interaction with a display assembly movably mounted to a chassis of the server, where the user interaction involves pulling out the display assembly from the chassis while the display assembly remains mechanically coupled to the chassis (block 610). For example, the device may detect such user interaction as described above.

As also shown in FIG. 6, process 600 may include generating a trigger signal in response to the detected user interaction (block 620). For example, the device may generate the trigger signal in response to the user action of pulling out the display assembly.

Further, process 600 may include retrieving, by a control circuit electrically coupled to a system management controller (e.g., a BMC) of the server, system information from the system management controller in response to the trigger signal. The system information may include a first set of data retrievable when the server is in a powered-off or standby state (block 630). For example, the device may retrieve such information from the BMC as described above.

As also shown in FIG. 6, process 600 may include providing the retrieved system information to a display panel of the display assembly for display (block 640). For example, the device may render the system information on the display panel as described above.

In some embodiments, the control circuit may be programmable to configure the system information to be retrieved (block 650). For example, the device may include a programmable control circuit that determines what system information to retrieve, as described above.

Process 600 may include additional implementations, such as any single implementation or any combination of implementations described below and/or in connection with other processes described elsewhere herein.

In a first implementation, process 600 further includes writing one or more values to one or more registers associated with the control circuit. These values may indicate one or more types of system information to be retrieved from the system management controller.

In a second implementation, alone or in combination with the first implementation, retrieving the system information from the system management controller may include communicating with the system management controller via an I²C bus or SGPIO interface.

In a third implementation, alone or in combination with the first and second implementations, retrieving the system information from the system management controller may include automatically retrieving, in response to the trigger signal, at least one of: a model identifier, manufacturing date, firmware version, software version, or field-replaceable unit (FRU) data stored in non-volatile memory that is accessible by the system management controller during the powered-off or standby state of the server.

In a fourth implementation, alone or in combination with one or more of the first through third implementations, the control circuit may include a programmable logic device implemented using a field-programmable gate array (FPGA), a complex programmable logic device (CPLD), or a microcontroller unit (MCU).

In a fifth implementation, alone or in combination with one or more of the first through fourth implementations, providing the retrieved system information to the display panel may include transmitting the retrieved system information through a flexible flat cable (FFC).

In a sixth implementation, alone or in combination with one or more of the first through fifth implementations, retrieving system information from the system management controller may include: automatically retrieving the first set of information that is retrievable when the server is in the powered-off or standby state; reading one or more registers associated with the control circuit to determine a second set of system information to be retrieved when the server is in a power-on state; and automatically retrieving the second set of system information.

Although FIG. 6 shows example blocks of process 600, in some embodiments, process 600 may include additional blocks, fewer blocks, different blocks, or blocks arranged in a different order than shown. Additionally or alternatively, two or more of the blocks of process 600 may be performed in parallel.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each process, method, and algorithm described in the preceding sections may be embodied in, and fully or partially automated by, code modules executed by one or more computer systems or computer processors including computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, including a number of instructions to cause a computing device (which may be a personal computer, a server, a network device, and the like) to execute all or some steps of the methods of the embodiments of the present application. The storage medium may include a flash drive, a portable hard drive, ROM, RAM, a magnetic disk, an optical disc, another medium operable to store program code, or any combination thereof.

Particular embodiments further provide a system including a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be included in program codes or instructions stored in a memory (e.g., a non-transitory computer-readable storage medium described above). Such an algorithm may include a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, C, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A device, comprising:
a display assembly movably mounted to a chassis of a server, comprising:
a display panel; and
a sensor configured to detect a user interaction with the display assembly and to generate a trigger signal in response to the user interaction; and
a control circuit disposed within the chassis, electrically coupled to the display assembly and to a system management controller of the server, the control circuit configured to:
automatically retrieve system information through the system management controller of the server in response to the trigger signal using a communication interface, the system information comprising at least a set of information retrievable when the server is in a powered-off or standby state; and
provide the retrieved system information to the display panel for presentation;
wherein the control circuit is programmable to configure the system information to be retrieved.

2. The device of claim 1, wherein the user interaction comprises pulling out the display assembly from the chassis while the display assembly remains mechanically coupled to the chassis and electrically coupled to the control circuit, wherein the pulling out of the display assembly automatically triggers the retrieval of the system information through the system management controller of the server.

3. The device of claim 1, wherein the sensor comprises a light sensor configured to detect light exposure when the display assembly is pulled out from the chassis.

4. The device of claim 1, wherein the control circuit comprises a programmable logic device implemented using a field-programmable gate array (FPGA), a complex programmable logic device (CPLD), or a microcontroller unit (MCU).

5. The device of claim 1, wherein the system management controller comprises a baseboard management controller (BMC).

6. The device of claim 1, wherein the communication interface between the control circuit and the system management controller comprises an inter-integrated circuit (I2C) bus or a serial general-purpose input/output (SGPIO) interface.

7. The device of claim 1, wherein the display panel is operatively coupled to the control circuit via a flexible flat cable (FFC) disposed within the chassis.

8. The device of claim 1, wherein the display panel is configured to present one or more of: a model identifier, a manufacturing date, a firmware version, a software version, a hardware configuration, or a temperature reading associated with the server.

9. The device of claim 1, wherein the set of information retrieved when the server is in the powered-off or standby state comprises: a model identifier, a manufacturing location, a manufacturing date, a serial number, field replaceable unit (FRU) data, or system voltage or temperature sensor data.

10. The device of claim 1, wherein the control circuit is further configured to:
automatically retrieve, in response to the trigger signal, at least one of: a model identifier, manufacturing date, firmware version, software version, or field replaceable unit (FRU) data stored in non-volatile memory that is accessible by the system management controller during the powered-off or standby state of the server.

11. The device of claim 1, wherein the control circuit is further configured to:
write one or more values to one or more registers associated with the control circuit, the one or more values indicating one or more types of system information to be retrieved from the system management controller.

12. The device of claim 1, wherein the display assembly is retractable and mounted to a side or bottom portion of the chassis.

13. The device of claim 1, wherein the display panel is configured to render content using a graphical user interface (GUI).

14. A method of retrieving and presenting static and dynamic system information in a server, comprising:
detecting user interaction with a display assembly movably mounted to a chassis of the server, the user interaction comprising pulling out the display assembly from the chassis while the display assembly remains mechanically coupled to the chassis;
generating a trigger signal in response to the detected user interaction;
retrieving, by a control circuit electrically coupled to a system management controller of the server, system information from the system management controller in response to the trigger signal, the system information comprising a first set of information retrievable when the server is in a powered-off or standby state; and
providing the retrieved system information to a display panel of the display assembly for display;
wherein the control circuit is programmable to configure the system information to be retrieved.

15. The method of claim 14, further comprising:
writing one or more values to one or more registers associated with the control circuit, the one or more values indicating one or more types of system information to be retrieved from the system management controller.

16. The method of claim 14, wherein the retrieving the system information from the system management controller comprises:
communicating with the system management controller via an I²C bus or SGPIO interface.

17. The method of claim 14, wherein the retrieving the system information from the system management controller comprises:
automatically retrieving, in response to the trigger signal, at least one of: a model identifier, manufacturing date, firmware version, software version, or field replaceable unit (FRU) data stored in non-volatile memory that is accessible by the system management controller during the powered-off or standby state of the server.

18. The method of claim 14, wherein the control circuit comprises a programmable logic device implemented using a field-programmable gate array (FPGA), a complex programmable logic device (CPLD), or a microcontroller unit (MCU).

19. The method of claim 14, wherein the providing the retrieved system information to the display panel comprises:
transmitting the retrieved system information through a flexible flat cable (FFC).

20. The method of claim 14, wherein the retrieving system information from the system management controller comprises:
automatically retrieving the first set of information that are retrievable when the server is in the powered-off or standby state;
reading one or more registers associated with the control circuit to determine a second set of system information to be retrieved from the system management controller when the server is in a power-on state; and
automatically retrieving the second set of system information.
